(19) United States
(12) Patent Application Publication
(10) Pub. No.: US 2012/0293607 A1
(43) Pub. Date: Nov. 22, 2012

(54) Panorama Processing

(75) Inventors: Nikhil Bhogal, San Francisco, CA (US); Frank Doepke, San Jose, CA (US)

(73) Assignee: Apple Inc., Cupertino, CA (US)

(21) Appl. No.: 13/109,875

(22) Filed: May 17, 2011

(51) Int. Cl. H04N 5/262

(52) U.S. Cl. 348/36; 348/239; 348/E05.051

(57) ABSTRACT

This disclosure pertains to devices, methods, and computer readable media for performing panoramic photography processing techniques in handheld personal electronic devices. A few generalized steps may be used to carry out the panoramic photography processing techniques described herein: 1.) acquiring image data from the electronic device's image sensor's image stream; 2.) displaying a scaled preview version of the image data in real-time on the device's display; 3.) performing “motion filtering” on the acquired image data; 4.) generating full-resolution and lower-resolution versions of portions of the images that are not filtered out by the “motion filtering” process; 5.) substantially simultaneously “stitching” both the full-resolution and lower-resolution image portions together to create the panoramic scene; and 6.) substantially simultaneously sending the stitched version of the lower-resolution image portions to a preview region on the device's display and storing the stitched version of the full-resolution image portions to a memory.

### CROSS-REFERENCE TO RELATED APPLICATIONS

This application is related to commonly-assigned applications with Attorney Docket Nos. P10712US1 (119-02241.6), P10713US1 (119-0225US), P10714US1 (119-0226US), and P10715US1 (119-0227US), each of which applications was filed on May 17, 2011, and each of which is hereby incorporated by reference in its entirety.

### BACKGROUND

The disclosed embodiments relate generally to panoramic photography. More specifically, the disclosed embodiments relate to techniques for improving real-time panoramic photography processing for handheld personal electronic devices with image sensors.

Panoramic photography may be defined generally as a photographic technique for capturing images with elongated fields of view. An image showing a field of view approximating, or greater than, that of the human eye, e.g., about 160° wide by 75° high, may be termed “panoramic.” Thus, panoramic images generally have an aspect ratio of 2:1 or larger, meaning that the image is at least twice as wide as it is high (or, conversely, twice as high as it is wide, in the case of vertical panoramic images). In some embodiments, panoramic images may even cover fields of vie, of up to 360 degrees, i.e., a “full rotation” panoramic image.

There are many challenges associated with taking visually appealing panoramic images. These challenges include photographic problems such as: difficulty in determining appropriate exposure settings caused by differences in lighting conditions across the panoramic scene; blurring across the seams of images caused by the motion of objects within the panoramic scene; and parallax problems, i.e., problems caused by the apparent displacement or difference in the apparent position of an object in the panoramic scene in consecutive captured images due to rotation of the camera about an axis other than its center of perspective (COP). The COP may be thought of as the point where the lines of sight viewed by the camera converge. The COP is also sometimes referred to as the “entrance pupil.” Depending on the camera's lens design, the entrance pupil location on the optical axis of the camera may be behind, within, or even in front of the lens system. It usually requires some amount of pre-capture experimentation, as well as the use of a rotatable tripod arrangement with a camera sliding assembly to ensure that a camera is rotated about its COP during the capture of a panoramic scene. This type of preparation and calculation is not desirable in the world of handheld, personal electronic devices and ad-hoc panoramic image capturing.

Other challenges associated with taking visually appealing panoramic images include post-processing problems such as: properly aligning the various images used to construct the overall panoramic image; blending between the overlapping regions of various images used to construct the overall panoramic image; choosing an image projection correction (e.g., rectangular, cylindrical, Mercator) that does not distort photographically important parts of the panoramic photograph; and correcting for perspective changes between subsequently captured images.

Further, it can be a challenge for a photographer to track his or her progress during a panoramic sweep, potentially resulting in the field of view of the camera gradually drifting upwards or downwards during the sweep (in the case of a horizontal the panoramic sweep). Some prior art panoramic photography systems assemble the constituent images to create the resultant panoramic image long after the constituent images have been captured, and often with the use of expensive post-processing software. If the coverage of the captured constituent images turns out to be insufficient to assemble the resultant panoramic image, the user is left without recourse. Heretofore, panoramic photography systems have been unable to provide a meaningful panoramic image preview to the user while simultaneously generating a full resolution version of the panoramic image during the panoramic sweep, such that the full resolution version of the panoramic image is ready for storage and/or viewing at substantially the same time as the panoramic sweep is completed by the user.

Accordingly, there is a need for techniques to improve the capture and processing of panoramic photographs on handheld, personal electronic devices such as mobile phones, personal data assistants (PDAs), portable music players, digital cameras, as well as laptop and tablet computer systems. By employing a split graphics processing pipeline operating on both full-resolution and lower-resolution portions of the captured images, more effective panoramic photography processing techniques, such as those described herein, may be employed to achieve visually appealing panoramic photography results and meaningful panoramic preview images in a way that is seamless and intuitive to the user.

### SUMMARY

The panoramic photography techniques disclosed herein are designed to handle the processing of panoramic scenes as they are being captured by handheld personal electronic devices while still providing a useful panoramic preview image to the user during the panoramic image captures. A few generalized steps may be used to carry out the panoramic photography techniques described herein: 1.) acquiring image data from the electronic device's Image sensor's image stream (this may come in the form of serially captured image frames as the user pans the device across the panoramic scene); 2.) displaying a scaled preview version of the image data in real-time on the device's display; 3.) performing “motion filtering” on the acquired image data (e.g., using information returned from positional sensors embedded in the handheld personal electronic device to inform the processing of the Image data); 4.) generating full-resolution and lower-resolution versions of portions, e.g., “slits” or “slices,” of images that are not filtered out by the “motion filtering” process; 5.) simultaneously “stitching” both the full-resolution and lower-resolution image “slits” or slices” together to create the panoramic scene. The stitching process may involve, e.g., aligning, geometrically correcting, and/or blending the image data in the overlapping regions between consecutively processed image “slits” or slices;” and 6.) substantially simultaneously sending the stitched version of the lower-resolution image “slits” or “slices” to a panoramic preview region on the device's display and storing the stitched version of the full-resolution image “slits” or “slices” to a memory. Due to image projection corrections, perspective corrections, alignment, and the like, the resultant stitched full-resolution panoramic it rage may have an irregular shape. Thus, the resultant stitched panoramic image may optionally be cropped to a rectangular shape before final storage if so desired. Each of these generalized steps will be described in greater detail below.

1. Image Acquisition

Some modern cameras' image sensors may capture image frames at the rate of 30 frames per second (fps), that is, one frame every approximately 0.03 seconds. At this high rate of image capture, and given the panning speed of the average panoramic photograph taken by a user, much of the image data captured by the image sensor is redundant, i.e., overlapping with image data in a subsequently or previously captured image frame. In fact, as will be described in further detail below, in some embodiments it may be advantageous to retain only a narrow “slit” or “slice” of each image frame after it has been captured. In some embodiments, the slit may comprise only the central 12.5% of the image frame. So long as there retains a sufficient amount of overlap (the amount of overlap required may depend on the capabilities of the image registration algorithm to be used to stitch the images together, with a smaller amount of overlap desired to limit the amount of processing required, while still generating satisfactory image alignment) between consecutively captured image sifts, the panoramic photography techniques described herein are still able to create a visually pleasing panoramic result, while operating with increased efficiency due to the large amounts of unnecessary and/or redundant data that may be discarded. Modern image sensors may capture both low dynamic range (LDR) and high dynamic range (HDR) images, and the techniques described herein may be applied to each.

2. Scaled Preview

Users of modern, image capturing personal electronic devices have become accustomed to having a live, full-frame preview of the image currently being captured by the device. By scaling down the data returned from the device's image sensor to the resolution of the device's display and sending such data down a first portion of a split graphics processing pipeline, the user of the device may stay aware of the device's current field of view and be able to make any necessary adjustments to camera settings and/or the direction, speed, etc. of the panoramic sweep in real-time. Scaling the preview image allows more processing bandwidth for other image data to be sent down the split graphics processing pipeline at substantially the same time for assembly into a resultant panoramic image and/or panoramic image preview.

3. Motion Filtering

One of the problems currently faced during ad-hoc panoramic image generation on handheld personal electronic devices is keeping the amount of data that is actually being used in the generation of the panoramic image in line with what the device's processing capabilities are able to handle. By using a heuristic of the camera motion based on previous frame registration, change in acceleration, and change of camera rotation information coming from an er bedded positional sensor within or otherwise in communication with the device, e.g., a gyrometer and/or accelerometer, it is possible to “filter out” image slits that would, due to lack of sufficient change in the camera's position, produce only redundant image data. This filtering is not computationally intensive and reduces the amount of image slits that do get passed on to the more computationally intensive parts of the panoramic image processing routine. Motion filtering also reduces the memory footprint of the panoramic image processing routine.

4. Image Portioning

Because of the large amount of redundant data captured by an image sensor operating at a frame rate of, e.g., 15 frames per second (fps) or 30 fps, many of the frames from the image sensor's image stream may be dropped from the panoramic photography process, while still providing sufficient coverage of the panoramic scene being captured, as discussed with reference to “motion filtering” above. Additionally, the inventors have surprisingly discovered that operating on only a portion of each of the image frames selected for additional processing by the “motion filter,” e.g., a central portion of each selected image frame, some optical artifacts such as barrel or pincushion distortions, lens shading, vignetting, etc. (which are more pronounced closer to the edges of a captured image) may be diminished or eliminated altogether. Further, operating on portions of each selected image frame creates a smaller memory footprint for the panoramic photography process, which may become important when assembling a full-resolution panoramic image, as will be discussed further below. In some embodiments, this image portion may comprise approximately the central 12.5% of the image frame, and is referred to herein as an image “slit” or “slice.”

5. Image Stitching

According to one embodiment described herein, each of the image slits selected for inclusion in the resultant panoramic image may subsequently be registered (i.e., aligned), blended in overlapping regions, and stitched together with other selected image portions, producing a resultant panoramic image portion. The selected image frame portions may be placed into an assembly buffer where the overlapping regions between the images may be determined, and the image pixel data in the overlapping region may be blended into a final resultant image region according to a blending formula, e.g., a linear, polynomial, or alpha blending formula. Blending between two successively captured image portions attempts to hide small differences between the frames but may also have the consequence of blurring the image in that area. According to one embodiment disclosed herein, the stitching process may take place substantially simultaneously on both the full-resolution and lower-resolution image “slits” or slices” to create two versions of the panoramic scene.

6. Dual Preview Pipeline

The panoramic photography process may send the stitched version of the lower-resolution image “slits” or “slices” to a preview region on the device's display while storing the stitched version of the full-resolution image “slits” or “slices” to a memory at substantially the same time. By doing so, one embodiment of the panoramic photography process disclosed herein may provide a meaningful panoramic image preview to the user while simultaneously generating a full resolution version of the panoramic image during the panoramic sweep, such that the full resolution version of the panoramic image is ready for storage and/or viewing at substantially the same time as the panoramic sweep is completed by the user.

Thus, in one embodiment described herein, an image processing method is disclosed comprising: obtaining a first image; displaying a first scaled version of the first image in a first region of a display at a first time; storing a full resolution version of a central portion of the first image in a memory; displaying a second scaled version of the central portion of the first image in a second region of the display at the first time; obtaining a second image; replacing the first scaled version of the first image in the first region of the display with a first scaled version of the second image at a second time; stitching a full resolution version of a central portion of the second image together with the full resolution version of the central portion of the first image to generate a first resultant stitched image, the central portion of the first image and the central portion of the second image sharing an overlapping region; storing the first resultant stitched image in the memory; stitching the second scaled version of the central portion of the first image together with a second scaled version of the central portion of the second image to generate a second resultant stitched image, the second scaled version of the central portion of the first image together and the second scaled version of the central portion of the second image sharing the overlapping region; and displaying the second resultant stitched image in the second region of the display at the second time.

In another embodiment described herein, an image processing method is disclosed comprising: receiving a stream of images captured by a camera in communication with a device, the stream of images comprising a panoramic scene; and for each received image: sending a first portion of data representative of the image down a first graphics pipeline for generating and displaying a real-time preview of the image at the device; and determining whether to filter the image, and, for each image wherein it is determined that the image will not be filtered: sending a second portion of data representative of the image down a second graphics pipeline for generating a portion of a panoramic preview of the image, wherein the generated portion of the panoramic preview of the image is stitched to the panoramic preview of the image, creating a resultant panoramic preview of the image, and wherein the resultant panoramic preview of the image is displayed in real-time at the device.

Panoramic photography processing techniques for handheld personal electronic devices in accordance with the various embodiments described herein may be implemented directly by a device's hardware and/or software, thus making these robust panoramic photography techniques readily applicable to any number of electronic devices with appropriate positional sensors and processing capabilities, such as mobile phones, personal data assistants (PDAs), portable music players, digital cameras, as well as laptop and tablet computer systems.

### BRIEF DESCRIPTION OF THE DRAWINGS

FIG. 1 illustrates a system for panoramic photography, in accordance with one embodiment.

FIG. 2 illustrates a process for creating panoramic images with the assistance of positional sensors, in accordance with one embodiment.

FIG. 3 illustrates an exemplary panoramic scene as captured by an electronic device, in accordance with one embodiment.

FIG. 4 illustrates a process for performing positional sensor-assisted motion filtering for panoramic photography, in accordance with one embodiment.

FIG. 5A illustrates an exemplary panoramic scene as captured by an electronic device panning across the scene with constant velocity, in accordance with one embodiment.

FIG. 5B illustrates an exemplary panoramic scene as captured by an electronic device panning across the scene with non-constant velocity, in accordance with one embodiment.

FIG. 6 illustrates image portions, i.e., image “slits” or “slices,” in accordance with one embodiment.

FIG. 7 illustrates image registration techniques utilizing feature detection, according to one embodiment.

FIG. 8 illustrates an exemplary stitched image, in accordance with the prior art.

FIG. 9 illustrates an exemplary stitched image comprising image slits, in accordance with one embodiment.

FIG. 10 illustrates a panoramic photography processing technique in flowchart form, in accordance with one embodiment.

FIG. 11A illustrates a real-time panoramic preview image, in accordance with one embodiment.

FIG. 11B illustrates an exemplary split graphics processing pipeline for panoramic photography, in accordance with one embodiment.

FIG. 12 illustrates a spot graphics processing pipeline system for panoramic photography, in accordance with one embodiment.

FIG. 13 illustrates a simplified functional block diagram of a representative electronic device possessing a display.

### DETAILED DESCRIPTION

This disclosure pertains to devices, methods, and computer readable media for performing panoramic photography processing techniques in handheld personal electronic devices. A few generalized steps may be used to carry out the panoramic photography processing techniques described herein: 1.) acquiring image data from the electronic device's image sensor's image stream (this may come in the form of serially captured image frames as the user pans the device across the panoramic scene); 2.) displaying a scaled preview version of the image data in real-time on the device's display; 3.) performing “motion filtering” on the acquired image data (e.g., using information returned from positional sensors embedded in the handheld personal electronic device to inform the processing of the image data); 4.) generating full-resolution and lower-resolution versions of portions, e.g., “slits” or “slices,” of images that are not filtered out by the “motion filtering” process; 5.) substantially simultaneously “stitching” both the full-resolution and lower-resolution image “slits” or slices” together to create the panoramic scene; and 6.) substantially simultaneously sending the stitched version of the lower-resolution image “slits” or “slices” to a preview region on the device's display and storing the stitched version of the full-resolution image “slits” or “slices” to a memory.

The techniques disclosed herein are applicable to any number of electronic devices with optical sensors such as digital cameras, digital video cameras, mobile phones, personal data assistants (PDAs), portable music players, as well as laptop and tablet computer systems.

In the interest of clarity, not all features of an actual implementation are described in this specification. It will of course be appreciated that in the development of any such actual implementation (as in any development project), numerous decisions must be made to achieve the developers' specific goals (e.g., compliance with system- and business-related constraints), and that these goals will vary from one implementation to another. It will be further appreciated that such development effort might be complex and time-consuming, but would nevertheless be a routine undertaking for those of ordinary skill having the benefit of this disclosure.

In the following description, for purposes of explanation, numerous specific details are set forth in order to provide a thorough understanding of the inventive concept. As part of the description, some structures and devices may be shown in block diagram form in order to avoid obscuring the invention. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

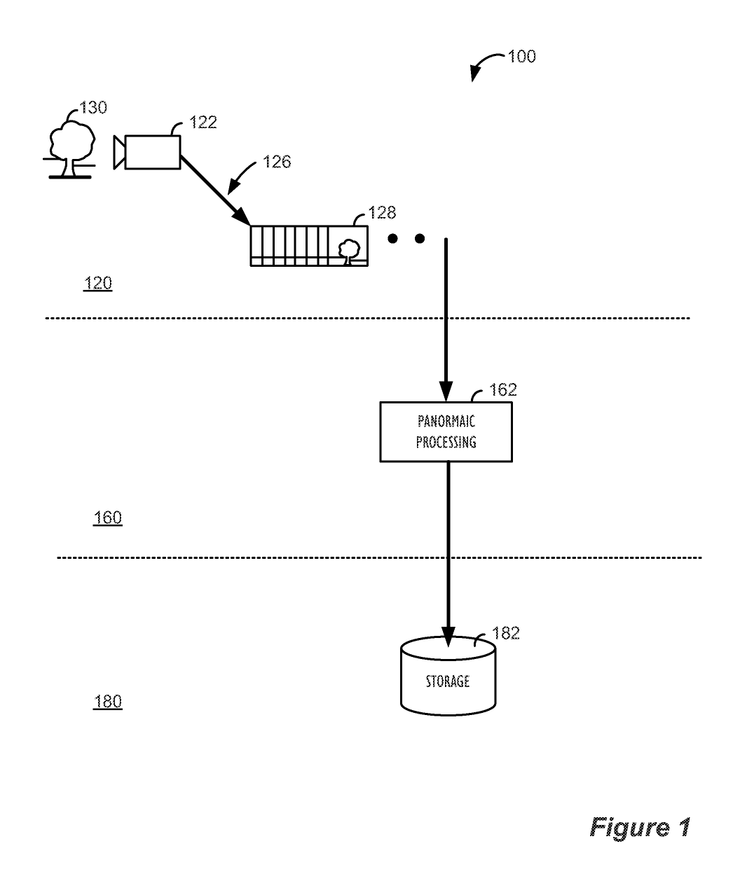

Referring now to FIG. 1, a system 100 for panoramic photography is shown, in accordance with one embodiment. The system 100 as depicted in FIG. 1 may be logically broken into three separate layers. Such layers are presented simply as a way to logically organize the functions of the panoramic photography system. In practice, the various layers could be within the same device or spread across multiple devices. Alternately, some layers may not be present at all in some embodiments.

First, the Camera Layer 120 will be described. Camera layer 120 comprises a personal electronic device 122 possessing one or more image sensors capable of capturing a stream of image data 126, e.g., in the form of an image stream or video stream of individual image frames 128. In some embodiments, images may be captured by an image sensor of the device 122 at the rate of 30 fps. As shown in the image frames 128 in image stream 126, tree object 130 has been captured by device 122 as it panned across the panoramic scene. Solid arrows in FIG. 1 represent the movement of image data.

Next, the Panoramic Processing Layer 160 is described in general terms. As mentioned above, the system 100 may possess panoramic processing module 162 which receives as input the image stream 128 from the Camera Layer 120. The panoramic processing module 162 may preferably reside at the level of an application running in the operating system of device 122, Panoramic processing module 162 may perform such tasks as: image registration, geometric correction, alignment, and “stitching” or blending. Finally, the panoramic processing module 162 may optionally crop the final panoramic image before sending it to Storage Layer 180 for permanent or temporary storage in storage unit 182. Storage unit 182 may comprise, for example, one or more different types of memory, for example, cache, ROM, and/or RAM.

As mentioned above, the device executing the panoramic photography process may possess certain positional sensors. Positional sensors may comprise, for example, a MEMS gyroscope, which allows for the calculation of the rotational change of the camera device from frame to frame, or a MEMS accelerometer, such as an ultra compact low-power three axes linear accelerometer. An accelerometer may include a sensing element and an integrated circuit (IC) interface able to provide the measured acceleration of the device through a serial interface. A motion filter module in communication with the device executing the panoramic photography process may receive input from the positional sensors of the device. Such information received from positional sensors may then be used by the motion filter module to make a determination of which image frames 128 in image stream 126 will be needed to efficiently construct the resultant panoramic scene. In some embodiments, the motion filter may keep only one of every roughly three images frames 128 captured by the image sensor of device 122, thus reducing the memory footprint of the process by two-thirds. By eliminating redundant image data in an intelligent and efficient manner, e.g., driven by positional information received from device 122's positional sensors, the motion filter module may be able to filter out a sufficient amount of extraneous image data such that the Panoramic Processing Layer 160 receives image frames having ideal overlap and is able to perform panoramic processing on high resolution and/or low resolution versions of the image data in real-time, optionally displaying the panoramic image to a display screen of device 122 as it is being assembled in real-time.

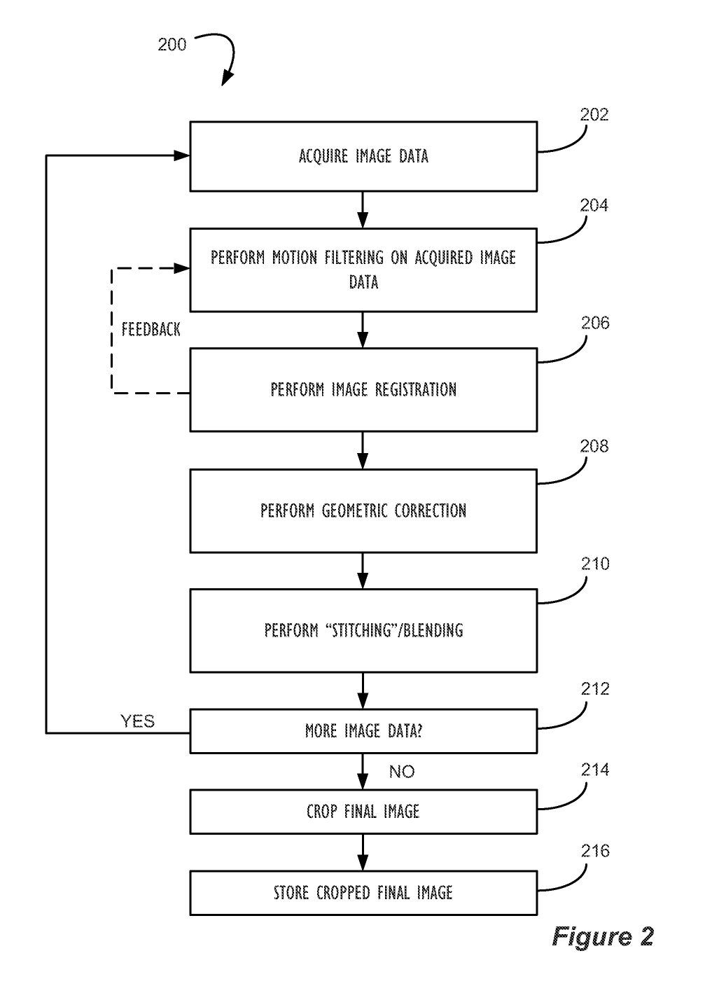

Referring now to FIG. 2, an illustrative process 200 for creating panoramic images with the assistance of positional sensors is shown at a high level in flow chart form, in accordance with one embodiment. First, an electronic device, e.g., a handheld personal electronic device comprising one or more image sensors and one or more positional sensors, captures image data using one or more of its image sensors, wherein the captured image data may take the form of an image stream of image frames (Step 202), Next, motion filtering is performed on the acquired image data, e.g., using the camera's positional sensors to assist in motion filtering decisions (Step 204). Once the motion filtered image stream has been created, the process 200 may attempt to perform image registration between successively captured image frames from the image stream (Step 206). The image registration process 206 may be streamlined and made more efficient via the use of information received from positional sensors within the device, as is explained in further detail in the U.S. patent application having Attorney Docket No. P10714US1 (119-0226US), which was incorporated by reference above. Next, any necessary geometric corrections may be performed on the captured image data (Step 208). The need for geometric correction of a captured image frame may be caused by, e.g., movement or rotation of the camera between successively captured image frames, which may change the perspective of the camera and result in parallax errors if the camera is not being rotated around its COP point. Next, the panoramic image process 200 may perform “stitching” and/or blending of the acquired image data (Step 210). If more image data remains to be appended to the resultant panoramic image (Step 212), the process 200 may return to Step 202 and run through the process 200 to acquire the next image frame that is to be processed and appended to the panoramic image. If instead, no further image data remains at Step 212, the final image may optionally be cropped (Step 214) and/or stored into some form of volatile or non-volatile memory (Step 216). It should also be noted that Step 202, the image acquisition step, may in actuality be happening continuously during the panoramic image capture process, i.e., concurrently with the performance of Steps 204-210. Thus, FIG. 2 is intended to for illustrative purposes only, and not to suggest that the act of capturing image data is a discrete event that ceases during the performance of Steps 204-210. Image acquisition continues until Step 212 when either the user of the camera device indicates a desire to stop the panoramic image capture process or when the camera device runs out of free memory allocated to the process.

Now that the panoramic imaging process 200 has been described at a high level both systemically and procedurally, attention will be turned in greater detail to both the process of efficiently and effectively creating panoramic photographs assisted by positional sensors in the image capturing device itself, as well as a split graphics processing pipeline operating on both full-resolution and lower-resolution portions of the captured images.

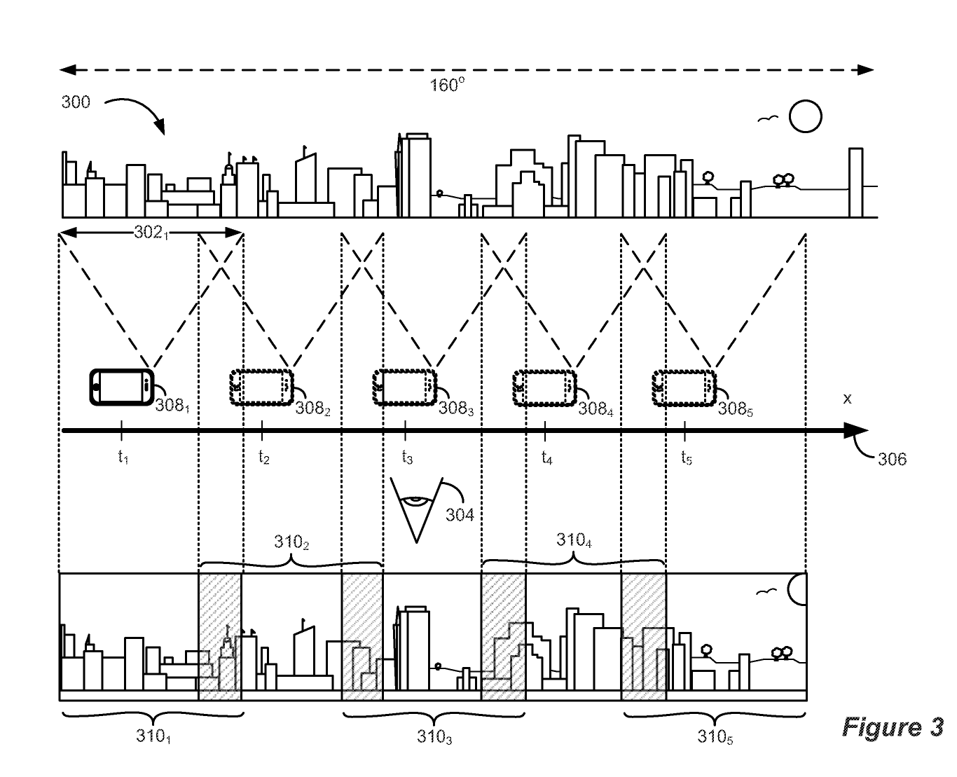

Turning now to FIG. 3, an exemplary panoramic scene 300 is shown as captured by an electronic device 308, according to one embodiment. As shown in FIG. 3, panoramic scene 300 comprises a series of architectural works comprising the skyline of a city. City skylines are one example of a wide field of view scene often desired to be captured in panoramic photographs. Ideally, a panoramic photograph may depict the scene in approximately the way that the human eye takes in the scene, i.e., with dose to a 180 degree field of view. As shown in FIG. 3, panoramic scene 300 comprises a 160 degree field of view.

Axis 306, which is labeled with an ‘x,’ represents an axis of directional movement of camera device 308 during the capture of panoramic scene 300. As shown in FIG. 3, camera device 308 is translated to the right with respect to the x-axis over a given time interval, t₁-t₅, capturing successive images of panoramic scene 300 as it moves along its panoramic path. In other embodiments, panoramic sweeps may involve rotation of the camera device about an axis, or a combination of camera rotation around an axis and camera translation along an axis. As shown by the dashed line versions of camera device 308, during the hypothetical panoramic scene capture illustrated in FIG. 3, camera device 308 will be at position 308₁ at time t₁, and then at position 308₂ at time t₂, and so on, until reaching position 308₅ at time t₅, at which point the panoramic path will be completed and the user 304 of camera device 308 will indicate to the device to stop capturing successive images of the panoramic scene 300.

Image frames 310₁-310₅ represent the image frames captured by camera device 308 at the corresponding times and locations during the hypothetical panoramic scene capture illustrated in FIG. 3. That is, image frame 310₁ corresponds to the image frame captured by camera device 308 while at position 308₁ and time t₁. Notice that camera device 308's field of view while at position 308₁, labeled 302₁, combined with the distance between user 304 and the panoramic scene 300 being captured dictates the amount of the panoramic scene that may be captured in a single image frame 310. In traditional panoramic photography, a photographer may take a series of individual photos of a panoramic scene at a number of different set locations, attempting to get complete coverage of the panoramic scene while still allowing for enough overlap between adjacent photographs so that they may be aligned and “stitched” together, e.g., using post-processing software running on a computer or the camera device itself. In some embodiments, a sufficient amount of overlap between adjacent photos is desired such that the post-processing software may determine how the adjacent photos align with each other so that they may then be stitched together and optionally blended in theft overlapping region to create the resulting panoramic scene. As shown in FIG. 3, the individual frames 310 exhibit roughly 25% overlap with adjacent image frames. In some embodiments, more overlap between adjacent image frames will be desired, depending on memory and processing constraints of the camera device and image registration algorithms being used.

In the case where camera device 308 is a video capture device, the camera may be capable of capturing 30 or more frames per second. As will be explained in greater detail below, at this rate of capture, much of the image data is redundant, and provides much more overlap between adjacent images than is needed by the stitching software to create the resultant panoramic images. As such, with positional-sensor assisted panoramic photography techniques, the device may be able to intelligently and efficiently determine which captured image frames may be used in the creation of the resulting panoramic image and which captured image frames may be discarded as overly redundant.

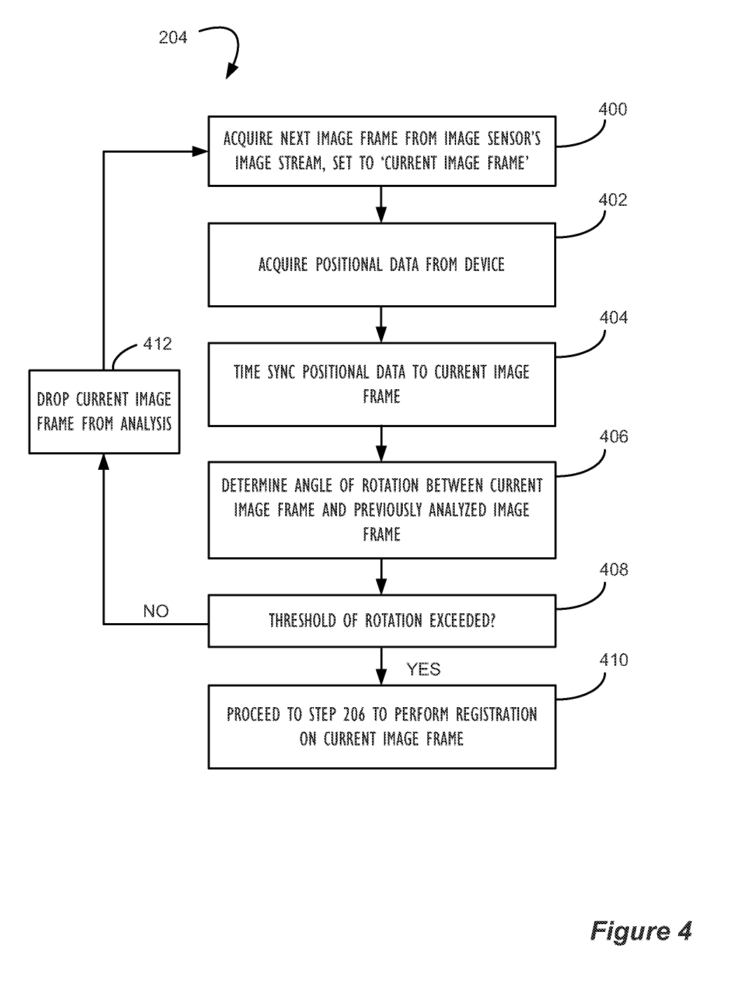

Referring now to FIG. 4, an illustrative process 204 for performing positional sensor-assisted motion filtering for panoramic photography is shown in flow chart form, in accordance with one embodiment. FIG. 4 provides greater detail to Motion Filtering Step 204, which was described above in reference to FIG. 2. First, an image frame is acquired from an image sensor of an electronic device, e.g., a handheld personal electronic device, and is designated the “current image frame” for the purposes of motion filtering (Step 400). Next, positional data is acquired, e.g., using the device's gyrometer or accelerometer (Step 402). At this point, if it has not already been done, the process 204 may need to correlate the positional data acquired from the accelerometer and/or gyrometer in time (i.e., time sync) with the acquired image frame. Because the camera device's image sensor and positional sensors may have different sampling rates and/or have different data processing rates, it may be important to know precisely which image frame(s) a given set of positional sensor data is linked to. In one embodiment, the process 204 may use as a reference point the first system interrupt to sync the image data with the positional data, and then rely on knowledge of sampling rates of the various positional sensors going forward to keep image data in proper time sync with the positional data. In another embodiment, periodic system interrupts may be used to update or maintain the synchronization information.

Next, the motion filtering process 204 may determine an angle of rotation between the current image frame and previously analyzed image frame (if there is one) using the positional sensor data (as well as feedback from image registration process 206) (Step 406). For example, the motion filtering process 204 may calculate an angle of rotation by integrating over the rotation angles of an interval of previously captured image frames and calculating a mean angle of rotation for the current image frame. In some embodiments, a “look up table” (LUT) may be consulted. In such an embodiment, the LUT may possess entries for various rotation amounts, which rotation amounts are linked therein to a number of images that may be filtered out from the assembly of the resultant panoramic image. If the angle of rotation for the current image frame has exceeded a threshold of rotation (Step 408), then the process 204 may proceed to Step 206 of the process flow chart illustrated in FIG. 2 to perform image registration (Step 410). If instead, at Step 408, t is determined that a threshold amount of rotation has not been exceeded for the current image frame, then the current image frame may be discarded filtered out from the assembly of the resultant panoramic image) (Step 412), and the process 204 may return to Step 400 to acquire the next captured image frame, at which point the process 204 may repeat the motion filtering analysis to determine whether the next frame is worth keeping for the resultant panoramic photograph. In other words, with motion filtering, the image frames discarded are not just every third frame or every fifth frame; rather, the image frames to be discarded are determined by the motion filtering module calculating what image frames will likely provide full coverage for the resultant assembled panoramic image.

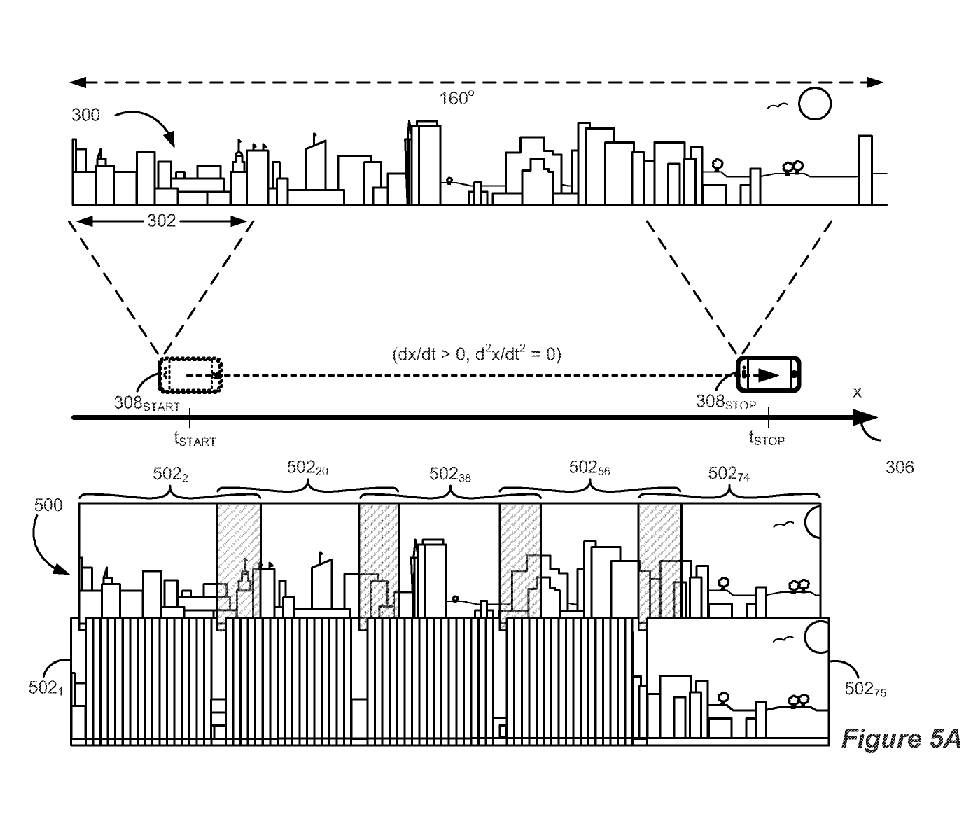

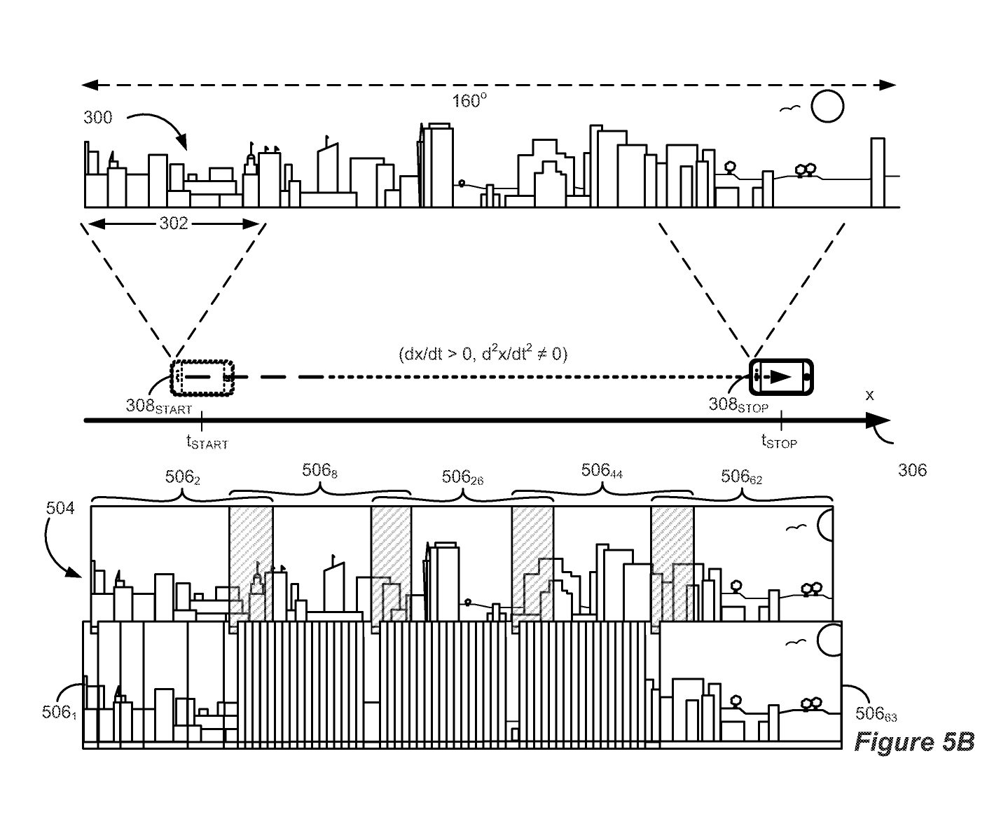

Turning now to FIG. 5A, an exemplary panoramic scene 300 is shown as captured by an electronic device 308 panning across the scene with constant velocity, according to one embodiment. FIG. 5A illustrates exemplary decisions that may be made by the motion filter module during a constant-velocity panoramic sweep across a panoramic scene. As shown in FIG. 5A, the panoramic sweep begins at device position 308_{START} and ends at position 308_{STOP}. The dashed line parallel to axis 306 representing the path of the panoramic sweep of device 308 is labeled with “(dx/dt>0, d²x/dt²=0)” to indicate that, while the device is moving with some velocity, its velocity is not changing during the panoramic sweep.

In the exemplary embodiment of FIG. 5A, device 308 is capturing a video image stream 500 at a frame rate, e.g., 30 frames per second. As such, and for the sake of example, a sweep lasting 2.5 seconds would capture 75 image frames 502, as is shown in FIG. 5A. Image frames 502 are labeled with subscripts ranging from 502₁-502₇₅ to indicate the order in which they were captured during the panoramic sweep of panoramic scene 300. As may be seen from the multitude of captured image frames 502, only a distinct subset of the image frames will be needed by the post-processing software to assemble the resultant panoramic photograph. By intelligently eliminating the redundant data, the panoramic photography process 200 may run more smoothly on device 308, even allowing device 308 to provide previews and assemble the resultant panoramic photograph in real time as the panoramic scene is being captured.

The frequency with which captured image frames may be selected for inclusion in the assembly of the resultant panoramic photograph may be dependent on any number of factors, including: device 308's field of view 302; the distance between the car era device 308 and the panoramic scene 300 being captured; as well as the speed and/or acceleration with which the camera device 308 is panned. In the exemplary embodiment of FIG. 5A, the motion filtering module has determined that image frames 502₂, 502₂₀, 502₃₈, 502₅₆, and 502₇₄ are needed for inclusion in the construction of the resultant panoramic photograph. In other words, roughly every 18^{th} captured image frame will be included in the construction of the resultant panoramic photograph in the example of FIG. 5A. As will be seen below in reference to FIG. 5B, the number of image frames captured between image frames selected by the motion filter module for inclusion may be greater or smaller than 18, and may indeed change throughout and during the panoramic sweep based on, e.g., the velocity of the camera device 308 during the sweep, acceleration or deceleration during the sweep, and rotation of the camera device 308 during the panoramic sweep.

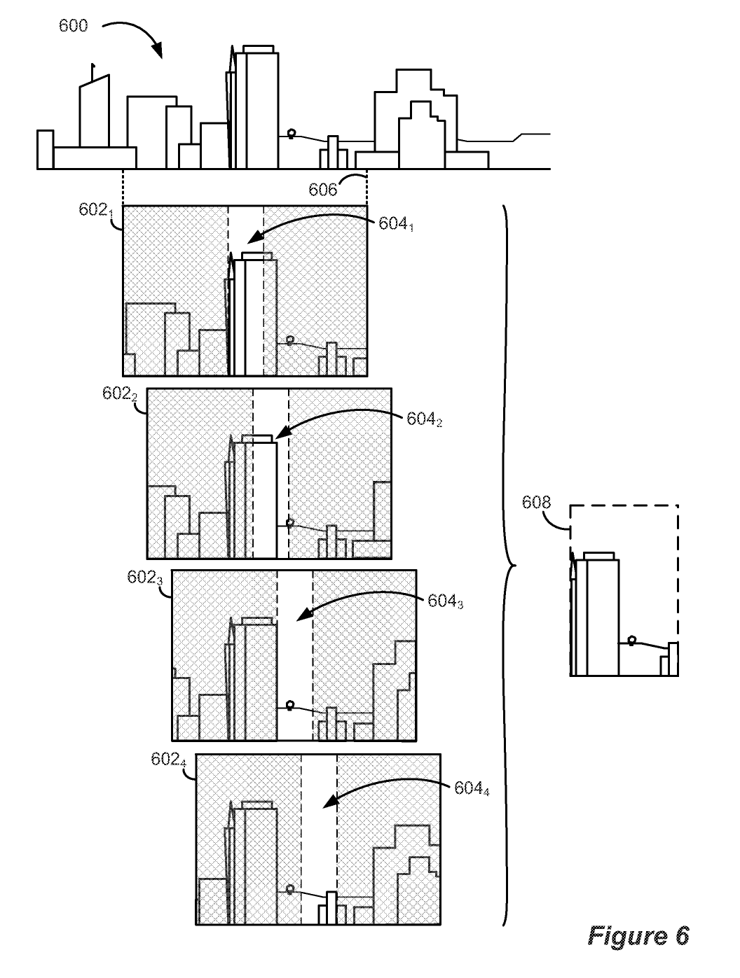

As shown in FIG. 5A, there is roughly 25% overlap between adjacent selected image frames. In some embodiments, more overlap between selected adjacent image frames will be desired; depending on memory and processing constraints of the camera device and image registration algorithm being used. As will be described in greater detail below with reference to FIG. 6, with large enough frames per second capture rates, even greater efficiencies may be achieved in the panoramic photograph process 200 by analyzing only a “slit” or “slice” of each captured image frame rather than the entire captured image frame.

Turning now to FIG. 58, an exemplary panoramic scene 300 is shown as captured by an electronic device 308 panning across the scene with non-constant velocity, according to one embodiment. FIG. 5B illustrates exemplary decisions that may be made by the motion filter module during a non-constant-velocity panoramic sweep across a panoramic scene. As shown in FIG. 58, the panoramic sweep begins at device position 308_{START} and ends at position 308_{STOP}. The dashed line parallel to axis 306 representing the path of the panoramic sweep of device 308 is labeled with “(dx/dt>0, d²x/dt²*0)” to indicate that, the device is moving with some non-zero velocity and its velocity changes along the panoramic path.

In the exemplary embodiment of FIG. 5B, device 308 is capturing a video image stream 504 at a frame rate, e.g., 30 frames per second. As such, and for the sake of example, a sweep lasting 2.1 seconds would capture 63 image frames 506, as is shown in FIG. 58. Image frames 506 are labeled with subscripts ranging from 506₁-506₆₃ to indicate the order in which they were captured during the panoramic sweep of panoramic scene 300.

In the exemplary embodiment of FIG. 58, the motion filtering module has determined that image frames 506₂, 506₈, 506₂₆, 506₄₄, and 506₆₂ are needed for inclusion in the construction of the resultant panoramic photograph. In other words, the number of image frames captured between image frames selected by the motion filter module may change throughout and during the panoramic sweep based on, e.g., the velocity of the camera device 308 during the sweep, acceleration or deceleration during the sweep, and rotation of the camera device 308 during the panoramic sweep.

As shown in FIG. 5B, movement of device 308 is faster during the first quarter of the panoramic sweep (compare the larger dashes in the dashed line at the beginning of the panoramic sweep to the smaller dashes in the dashed line at the end of the panoramic sweep). As such, the motion filter module has determined that, after selection image frame 506₂, by the time the camera device 308 has captured just six subsequent image frames, there has been sufficient movement of the camera across the panoramic scene 300 (due to the camera device's rotation, translation, or a combination of each) that image frame 506₈ must be selected for inclusion in the resultant panoramic photograph. Subsequent to the capture of image frame 506₈, the movement of camera device 308 during the panoramic sweep has slowed down to a level more akin to the pace of the panoramic sweep described above in reference to FIG. 5A. As such, the motion filter module may determine again that capturing every 18^{th} frame will provide sufficient coverage of the panoramic scene. Thus, image frames 506₂₆, 506₄₄, and 506₆₂ are selected for inclusion in the construction of the resultant panoramic photograph. By reacting to the motion of the camera device 308 in real time, the panoramic photography process 200 may intelligently and efficiently select image data to send to the more computationally-expensive registration and stitching portions of the panoramic photography process 200. In other words, the rate at which the act of motion filtering occurs may be directly related to the rate at which the device is being accelerated and/or rotated during image capture.

As mentioned above, modern image sensors are capable of capturing fairly large images, e.g., eight megapixel images, at a fairly high capture rate, e.g., thirty frames per second. Given the panning speed of the average panoramic photograph, these image sensors are capable of producing—though not necessarily processing—a very large amount of data in a very short amount of time. Much of this produced image data has a great deal of overlap between successively captured image frames. Thus, the inventors have realized that operating on only a portion of each selected image frame, e.g., a “slit” or “slice” of the image frame, greater efficiencies may be achieved. In a preferred embodiment, the slit may comprises the central 12.5% of each image frame.

Turning now to FIG. 6, image “slits” or “slices” 604 are shown, in accordance with one embodiment. In FIG. 6, panoramic scene 600 has been captured via a sequence of selected image frames labeled 602₁-602₄. As discussed above with reference to motion filtering, the selected image frames labeled 602₁-602₄ may represent the image frames needed to achieve full coverage of a portion of panoramic scene 600. Trace lines 606 indicate the portion of the panoramic scene 600 corresponding to the first captured image frame 602₁. The central portion 604 of each captured image frame 602 represents the selected image slit or slice that will be used in the construction of the resultant panoramic photograph. As shown in FIG. 6, the images slits comprise approximately the central 12.5% of the image frame. The shaded areas of the mages frames 602 may likewise be discarded as overly redundant of other captured image data. According to one embodiment described herein, each of selected image slits labeled 604₁-604₄ may subsequently be aligned, stitched together, and blended in their overlapping regions, producing resultant panoramic image portion 608. Potion 608 represents the region of the panoramic scene captured in the four image slits 604₁-604₄. Additionally, the inventors have surprisingly discovered that operating on only a portion of each of the image frames selected for additional processing by the motion filter, e.g., a central portion of each selected image frame, some optical artifacts such as barrel or pincushion distortions, lens shading, vignetting, etc. (which are more pronounced closer to the edges of a captured image) may be diminished or eliminated altogether. Further, operating on only portions of each selected image frame creates a smaller instantaneous memory footprint for the panoramic photography process 200, which may become important when assembling a full-resolution panoramic image, as will be discussed further below.

The process 206 of image registration, as applied in one embodiment of positional sensor-assisted panoramic photography, will now be described at a high-level. Further details about the process of image registration are explained in further detail in the U.S. patent application having Attorney Docket No. P10714US1 (119-0226US), which was incorporated by reference above.

Thus, in general terms, the registration process 206 may acquire the two images (or image sifts) that are to be registered, and then divide each image into a plurality of segments. In addition to the image information, the process 206 may acquire the positional information corresponding to the image frames to be registered. Through the use of an image registration algorithm involving, e.g., a feature detection algorithm (or a cross-correlation algorithm, a search vector may be calculated for each segment of the image. A segment search vector may be defined as a vector representative of the transformation that would need to be applied to the segment from the first image to give it its location in the second image. Once search vectors have been calculated, the process 206 may consider the positional information acquired from the device's positional sensors and drop any search vectors for segments where the computed search vector is not consistent with the acquired positional data. That is, the process 206 may discard any search vectors that are opposed to or substantially opposed to a direction of movement indicated by the positional information. For example, if the positional information indicates the camera has been rotated to the right between successive image frames, and an object in the image moves to the right opposed to the direction that would be expected given the camera movement) or even stays stationary from one captured image to the next, the process 206 may determine that the particular segments represents an outlier or an otherwise unhelpful search vector. Segment search vectors that are opposed to the expected motion given the positional sensor information may then be dropped from the overall image registration calculation.

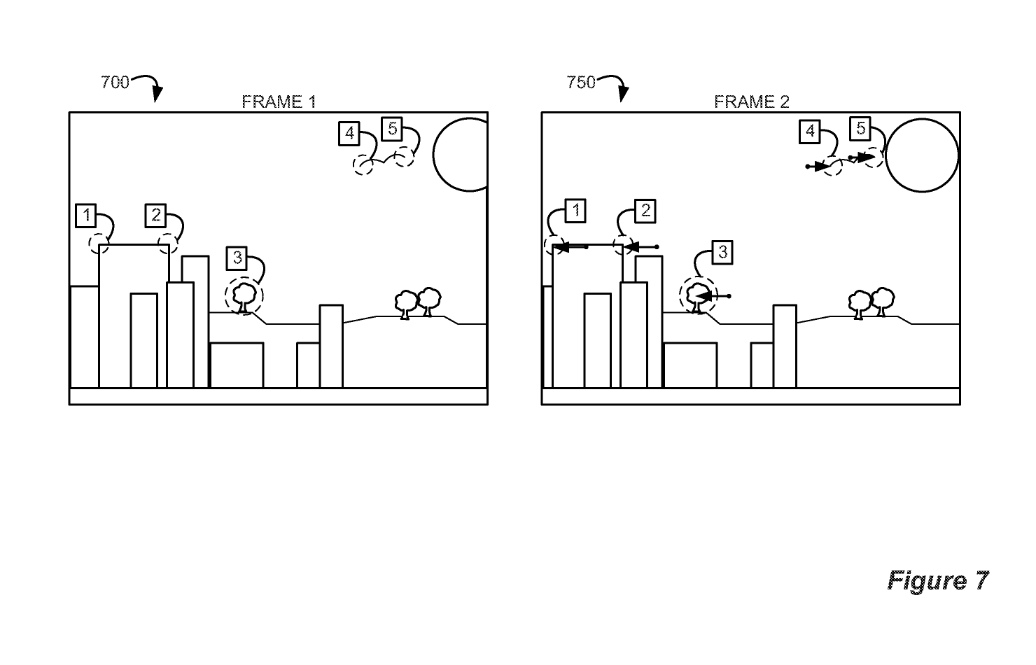

Turning now to FIG. 7, positional information-assisted feature detection is illustrated, according to one embodiment. In FIG. 7, a first frame 700 is illustrated and labeled “FRAME 1” and a second frame 750 is illustrated and labeled “FRAME 2.” FRAME 1 represents an image captured immediately before, or nearly immediately before FRAME 2 during a camera pan moving to the right. As such, the expected motion of stationary objects in the image will be to the left with respect to a viewer of the image. Thus, local subject motion opposite the direction of the camera's motion will be to the right (or even appear stationary if the object is moving at the same relative speed as the camera). Of course, local subject motion may be in any number of directions, at any speed, and located throughout the image. The important observation to make is that it not in accordance with the majority of the motion between the successively captured images, and thus, it would hinder image registration calculations rather than aid them.

The search vectors for five exemplary features located (numbered 1-5) in FRAME 1 and FRAME 2 are now examined in greater detail. Features 1 and 2 correspond to the edges or corners of one of the buildings in the panoramic scene. As is shown in FRAME 2, these two features have moved in leftward direction between the frames. This is expected movement, given the motion of the camera direction to the right. Feature 3 likewise represents a stationary feature, e.g., a tree, that has moved in the expected direction between frames, given the direction of the camera's motion. Features 4 and 5 correspond the edges near the wingtips of a bird. As the panoramic scene was being captured, the bird may have been flying in the direction of the camera's motion, thus, the search vectors calculated for Features 4 and 5 are directed to the right, and opposed to the direction of Features 1, 2, and 3. This type of local subject motion may worsen the image registration determination since it does not actually evidence the overall translation vector from FRAME 1 to FRAME 2. As such, and using cues received from the positional sensors in the device capturing the panoramic scene, such features (or, more accurately, the regions of image data surrounding such features) may be discarded from the image registration determination.

Discussion will turn now to a general overview of the image stitching process for panoramic photography. The process of image stitching may be explained in further detail in the U.S. patent application having Attorney Docket No. P10715US1 (119-0227US), which was incorporated by reference above, First, the stitching process 210 acquires two or more image frames to be stitched together and places them in, for example, an assembly buffer in order to work on them. At this point in the panoramic photography process 200, the two images may already have been motion filtered, registered, geometrically corrected, etc., as desired, and as described above in accordance with various embodiments.

In some panoramic photography post-processing software systems, part of the stitching process 210 comprises blending in the overlapping region between two successively captured image frames in an attempt to hide small differences between the frames. The process 210 may blend the image data in the overlapping region between the images according to any number of suitable blending formulae. For example, the image data may be blended across the overlapping region according to an alpha blending scheme or a simple linear or polynomial blending function based on the distance of the pixel being blended from the center of the relevant source image. Finally, the resultant stitched image (comprising the previous image, the current image, and the blended overlapping region) may be stored to memory either on the camera device itself or elsewhere.

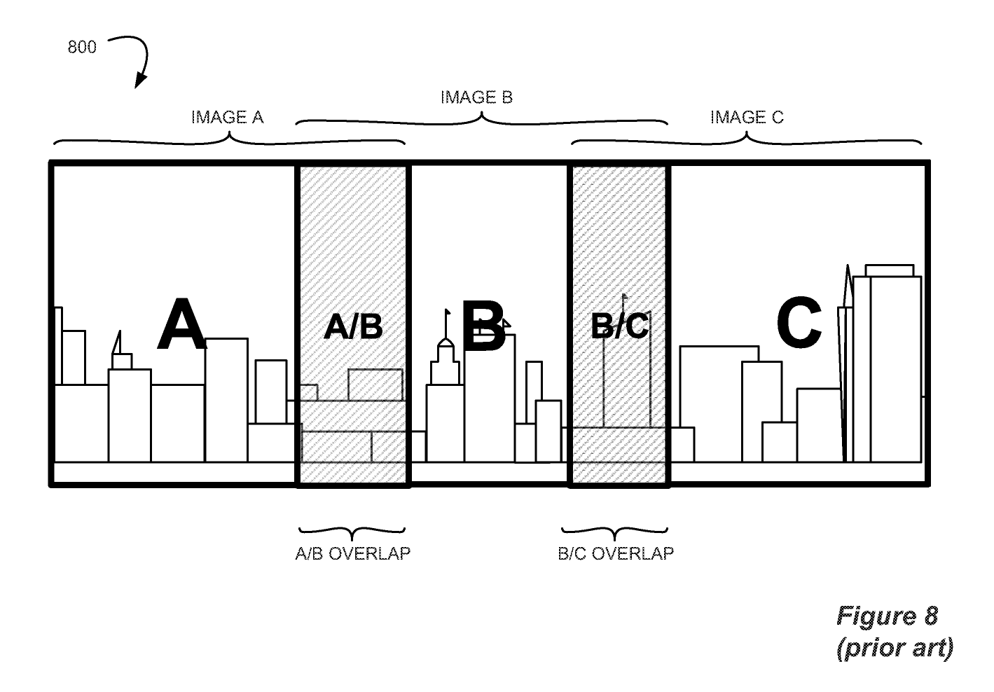

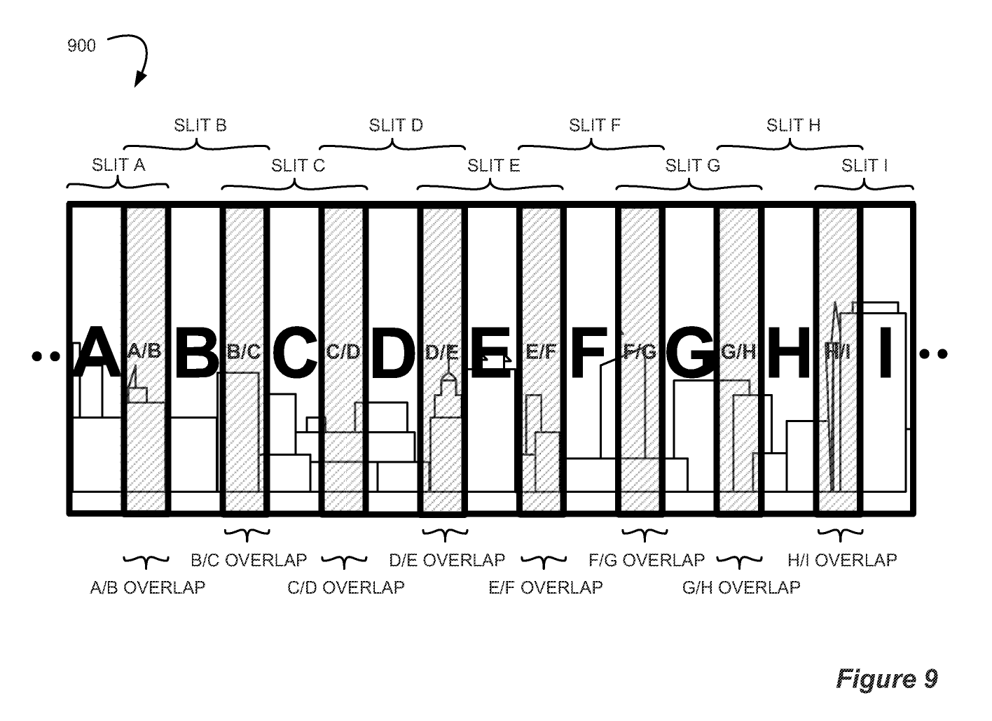

Referring now to FIG. 8, an exemplary stitched panoramic image 800 is shown, according to the prior art. The panoramic image 800 shown in FIG. 9 comprises image data from three distinct images: Image A, Image B, and Image C. The outlines of each image are shown in thick black lines, and the extent of each image is shown by a curly brace with a corresponding image label. Additionally, the overlapping regions in the image are also shown by curly braces with corresponding labels, “A/B OVERLAP” and “B/C OVERLAP,” Moving from left to right in the panoramic image 800, there is a region comprising only image data from Image A (labeled with ‘A’), then an overlapping region comprising blended image data from both Images A and B (labeled with ‘A/B’), then a region comprising of only image data from Image B (labeled with ‘B’), then an overlapping region comprising blended image data from both Images B and C (labeled with ‘B/C’), and finally, a region comprising of only image data from Image C (labeled with ‘C’).

Referring now to FIG. 9, an exemplary stitched panoramic image 900 comprised of image sifts is shown, according to one embodiment. The panoramic image 900 shown in FIG. 9 comprises image data from nine distinct images: Slit A-Slit I. Notice that the same amount of the panoramic scene is captured in images 800 and 900, although panoramic image 900 comprised of image slits contains information from a larger number of smaller-sued constituent image portions. As mentioned above, the use of image slits may provide for improvements from both an instantaneous memory footprint standpoint and a processing standpoint.

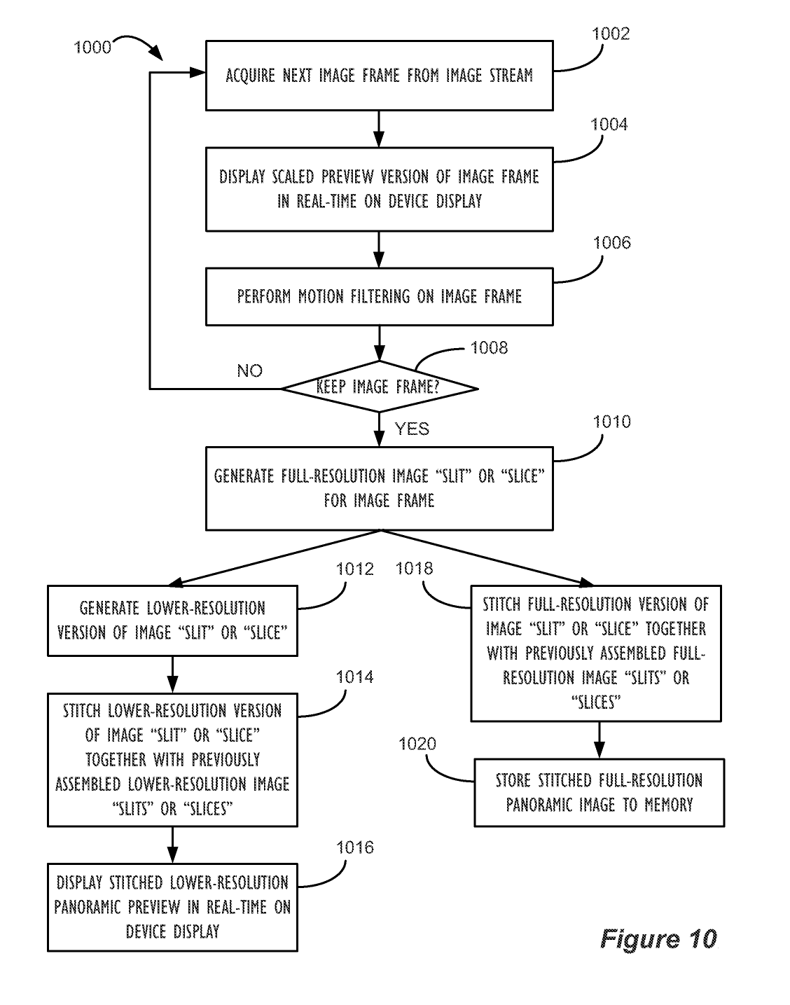

Referring now to FIG. 10, a panoramic photography processing technique is shown in flowchart form, in accordance with one embodiment. First, the process 1000 begins by acquiring the next image from the image sensor's image stream (Step 1002). It may then display a scaled preview version of the image frame in real-time on the device's display so that the user knows the extent of the camera device's current field of view (Step 1004). At this point, the process 1000 may feed the image data through the motion filtering module and perform the motion filtering process 204 described above in reference to FIG. 4 (Step 1006). For each captured image frame, a decision can be made as to whether or not the image frame is to be kept or discarded (Step 1008). If, at Step 1008, the image is discarded, e.g., due to redundancy, the process 1000 may return to Step 1002 and acquire the next image frame from the image stream so it may likewise be previewed and analyzed by the motion filter module. If, instead at Step 1008, it is determined that the image frame is necessary for the resultant panoramic image in order to sufficiently cover the panoramic scene, the process 1000 may proceed to generate an image portion (Step 1010). In one embodiment the image portion comprises one full resolution image “slit” or “slice.” In some embodiments, the image portion may comprise the central quadrant of the image frame.

At this point in the process 1000, the image data may travel down two separate paths. Along one path, the process 1000 proceeds to Step 1012, wherein a lower-resolution version of the image portion may be generated. This lower-resolution version of the current image portion may then be stitched together with any previously assembled lower-resolution image portions in order to create a lower-resolution panoramic image preview (Step 1014). As each incoming lower-resolution image portion is stitched together with the growing panoramic image preview, the resultant panoramic preview image may be sent to the device's display to provide the user with a real-time or near real-time progress indicator for the panoramic image that is currently being captured (Step 1016). In some embodiments, the growing panoramic image preview may be overlaid on the device display with the scaled preview version of image referred to in Step 1004 above.

Returning to Step 1010, the second path that the full-resolution image portion data may travel down proceeds to Step 1018. In some embodiments, the image data may travel down the two paths (i.e., from Step 1010 to Steps 1012 and 1018) substantially simultaneously. At Step 1018, the process 1000 may stitch the full-resolution image portion data image together with any previously assembled full-resolution image portions in order to create a full-resolution panoramic image. As each incoming full-resolution image portion is stitched together with the growing panoramic image, the resultant panoramic image may be stored to the device's memory (either volatile or non-volatile), such that, when the panoramic sweep has been completed by the user, the resultant full-resolution panoramic image has been assembled, stored, and is ready for viewing or other manipulation by the user (Step 1020). By sending a separate, scaled version of the full image frame to the device's display in real time, while simultaneously employing motion filtering and performing stitching on image portions, the panoramic photography process 200 described herein may provide the user with a seamless user experience including real-time progress feedback on the panoramic scene being captured, while simultaneously performing image stitching in substantially real-time—a feat previously thought to be too processing-intensive to achieve using handheld personal electronic devices.

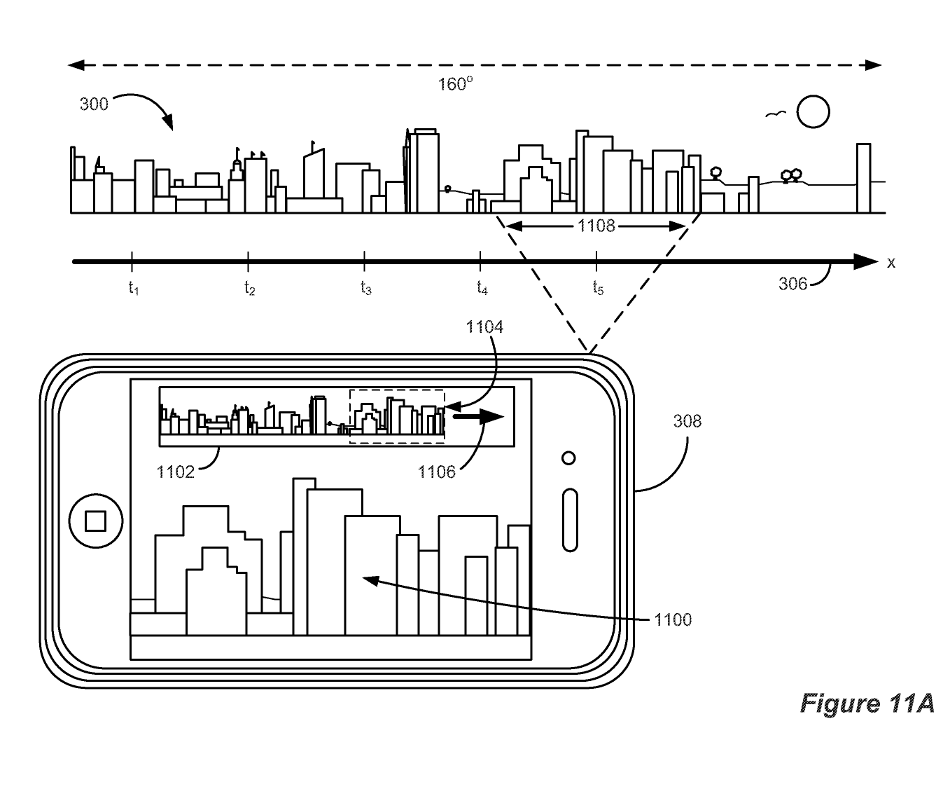

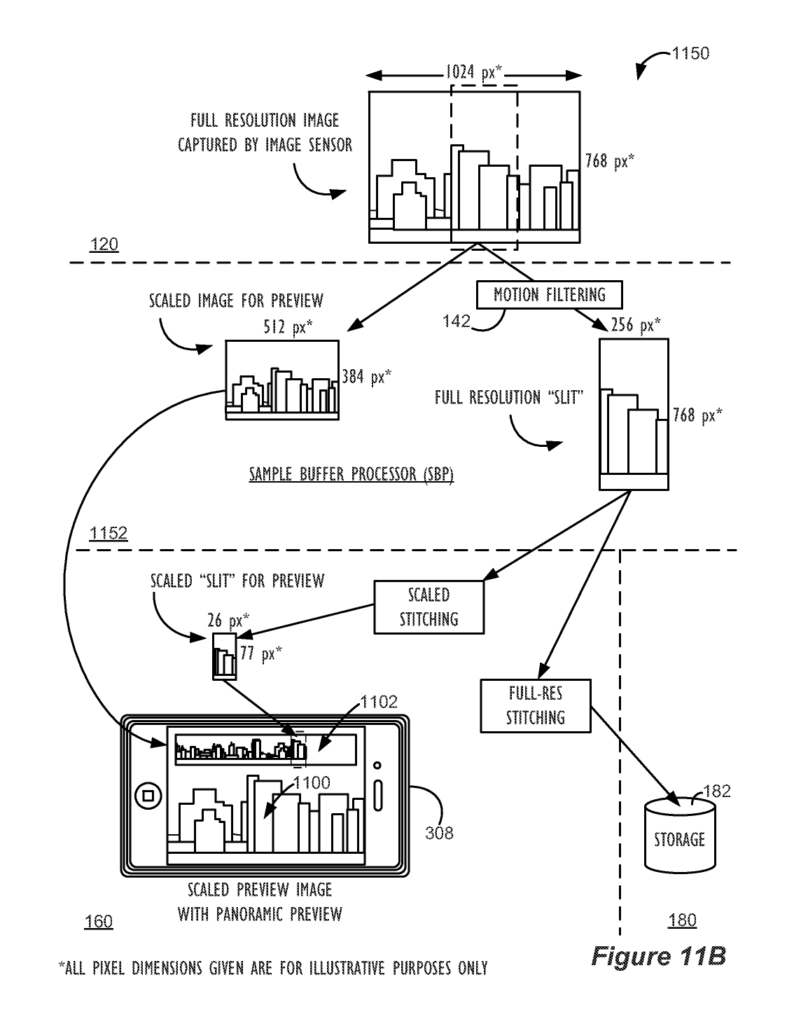

Referring now to FIG. 11A, a real-time panoramic preview image 1102 is shown, in accordance with one embodiment. As shown in FIG. 11A, device 308 is involved in a panoramic sweep along the x-axis 306 that has lasted from time t₁ to t₅. At time t₅, the field of view of device 308 is represented by arrow 1108. As such, the portion of panoramic scene 300 within the field of view 1108 of the device 308 is displayed as a full-screen preview image 1100 on the display of device 308. In addition to full-screen preview image 1100, panoramic preview image 1102 is overlaid on the display of device 308. Panoramic preview image 1102 represents the entire assembled panoramic image that has been captured by the device between times t₁ and t₅. As mentioned above in reference to FIG. 10, in some embodiments, the panoramic preview image 1102 may comprise a plurality of stitched lower-resolution image portions from the image frames captured by the image sensor(s) of device 308. Simultaneously, the full-resolution versions of the image portions may be assembled and stitched together by a processor in the device “behind the scenes” while the lower-resolution panoramic preview image is displayed to the user. Panoramic preview window 1104 represents the portion of the panoramic preview image 1102 corresponding to the currently being displayed preview image 1100. Arrow 1106 designates (for illustration purposes only) the direction of the panoramic sweep and, thus, the direction in which the panoramic preview image is growing. If the user was to reverse the direction of the camera device's movement during the panoramic sweep, or otherwise cover parts of the scene already captured, the motion filtering module would determine that such data was redundant and skip processing Steps 206-210.

Referring now to FIG. 11B, an exemplary split graphics processing pipeline 1150 for panoramic photography is shown, in accordance with one embodiment. At the top of the pipeline 1150 is the Camera Layer 120 (first introduced with reference to FIG. 1). Within the Camera Layer is a representation of an exemplary full resolution image as captured by the image sensor(s) of the camera device 308. In the example of FIG. 11B, the full resolution image has an exemplary size of 1,024 pixels wide by 768 pixels high. In practice, image sensors may capture much larger images, e.g., eight megapixel images, which could have dimensions such as 3,456 pixels wide by 2,304 pixels high. In FIG. 11B, the exemplary full resolution image is sent down a split graphics processing pipeline to a Sample Buffer Processor (SBP) 1152, with one path on the processing pipeline generating a scaled image for preview on the device display, and the other path sending the image data to a motion filtering module 142. The scaled image for preview may be shown with dimensions of 512 pixels wide by 384 pixels high, but the original image sensor data could be scaled by any factor that was appropriate for the display size and display resolution of the device. The scaled preview image may be sent by the SBP 1152 directly to the device 308 for real-tinge display as preview image 1100.

The portion of the image data sent to the motion filtering module 142 may be processed according to the motion filtering routine described above with reference to FIG. 4. When the motion filter module determines that a given image frame is needed for inclusion in the resultant panoramic image, the split graphics processing pipeline may generate a full-resolution image “slit” or “slice,” As shown in FIG. 11B, the full-resolution slit has dimensions of 256 pixels wide by 768 pixels high. In other words, the full-resolution has the same height—but only one-fourth of the width—of the full-resolution image captured by the image sensor. In other embodiments, the slit may be even narrow, e.g., one-eighth of the width of the full-resolution captured image. Once the full-resolution slit has been created by the SBP 1152, the portion of the image data comprising the full-resolution sift may be sent to the Panoramic Processing Layer 160.

At the Panoramic Processing Layer 160, two separate stitching processes may be carried out substantially simultaneously. In one stitching process, the full-resolution sift may be stitched together with the previously received and stitched full-resolution slits. The resultant full-resolution panoramic image may then be stored in storage 182 of the Storage Layer 180. In the other stitching process, a lower-resolution version of the sift may be generated. As shown in FIG. 11B, the lower-resolution version of the slit has dimensions of 26 pixels wide by 77 pixels high. In other words, the lower-resolution sift is one-tenth the width and one-tenth the height of the full-resolution slit. As such, the lower-resolution sift may be stitched together with the previously received and stitched lower-resolution slits and displayed in real-time to the device in the form of panoramic preview image 1102. Due to the relatively small size of the lower-resolution image slits used for the panoramic preview image, such processing may be done with substantially less processing power than the full-resolution stitching process. By operating on image slits, the process 200 may be able to handle ad-hoc panoramic sweeps, i.e., panoramic sweeps without pre-defined start and stop times, while still providing a panoramic preview image showing the entire panoramic sweep and working behind the scenes on full-resolution panoramic image creation.

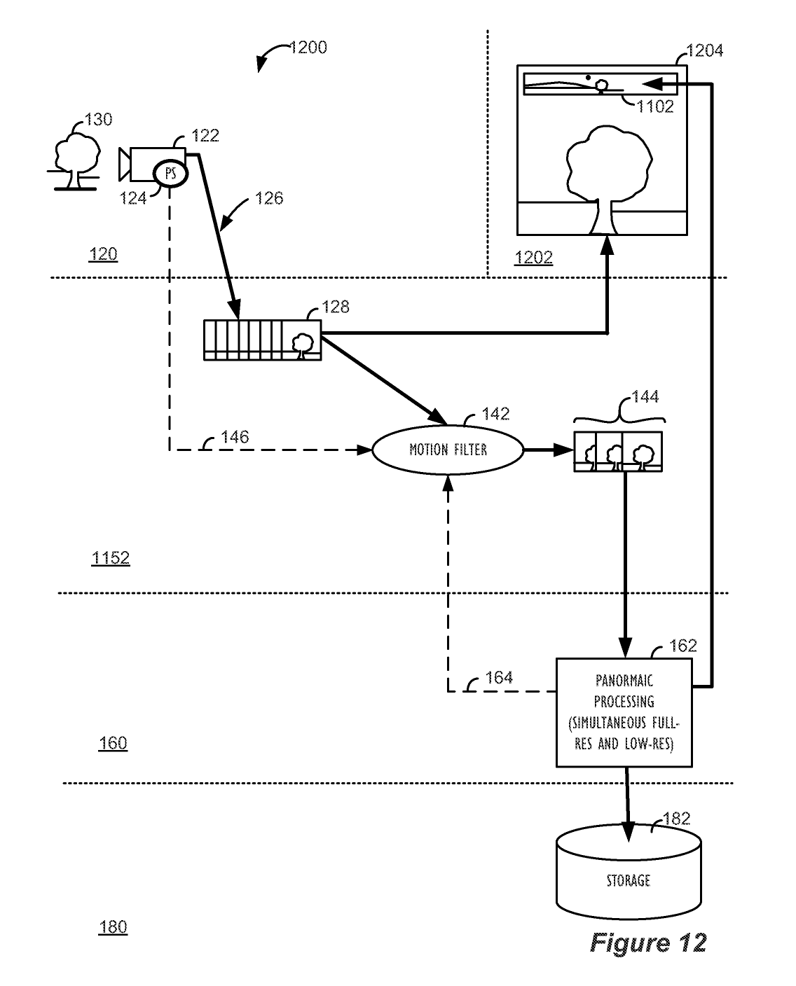

Referring now to FIG. 12, an illustrative split graphics processing pipeline system 1200 for panoramic photography is shown, in accordance with one embodiment. As in the panoramic photography system described above in reference to FIG. 1, a camera device 122 possesses one or more image sensors capable of capturing a stream of image data 126, e.g., in the form of an image stream or video stream of individual image frames 128. As shown in FIG. 12, device 122 also comprises positional sensors 124. Positional sensors 124 may comprise, for example, a MEMS gyroscope, which allows for the calculation of the rotational change of the camera device from frame to frame, or a MEMS accelerometer able to provide the measured acceleration of the device through a serial interface. As shown in the image frames 128 in image stream 126, tree object 130 has been captured by device 122 as it panned across the panoramic scene. Solid arrows in FIG. 12 represent the movement of image data, whereas dashed line arrows represent the movement of metadata or other information descriptive of the actual image data.

Next, the Sample Buffer Processing (SBP) Layer 1152 will be described. The SBP layer 1152 may comprise a motion filter module 142 that receives input 146 from the positional sensors 124 of device 122. Such information received from positional sensors 124 is used by motion filter module 142 to make a determination of which image frames 128 in image stream 126 will be used to construct the resultant panoramic scene. As may be seen by examining the exemplary motion filtered image stream 144, the motion filter is keeping only one of every roughly three images frames 128 captured by the image sensor of device 122. By eliminating redundant image data in an intelligent and efficient manner, e.g., driven by positional information received from device 122's positional sensors 124, motion filter module 142 may be able to filter out a sufficient amount of redundant image data such that the Panoramic Processing Layer 160 receives image frames having ideal or near ideal overlap and is, therefore, able to perform panoramic processing on high resolution and/or low resolution versions of the image data in real-time, optionally displaying a preview of the panoramic image 1102 to a display screen 1204 in communication with device 122 as it is being assembled in real-time.

Panoramic Processing Layer 160, as mentioned above, possesses panoramic processing module 162 which receives as input the motion filtered image stream 144 from the SBP Layer 1152. The panoramic processing module 162 may preferably reside at the level of an application running in the operating system of device 122. Panoramic processing module 162 may perform such tasks as: image registration, geometric correction, alignment, stitching, and blending on both full-resolution and lower-resolution image portions in a substantially simultaneous manner, as described above in reference to FIGS. 10, 11A, and 11B.

As discussed above, the lower-resolution panoramic image preview may be sent directly to Display Layer 1202 in the form of panoramic image preview overlay 1102, which may be displayed in real-time or near real-time on display 1204. The full-resolution panoramic image may likewise be assembled by panoramic processing module 162. Finally, when the user has indicated that he or she is done capturing the panoramic image, the panoramic processing module 162 may optionally crop the final panoramic image before sending it to Storage Layer 180 for permanent or temporary storage in storage unit 182. Because of the efficiencies gained using the techniques described herein, panoramic images may be stored and/or displayed on the device in real-time as they are being assembled. This type of memory flexibility may also allow the user to define the starting and stopping points for the panoramic sweep on the fly, even allowing for panoramic rotations of greater than 360 degrees.

Panoramic processing module 162 may also provide feedback image registration information 164 to the motion filter module 142 to allow the motion filter module 142 to make more accurate decisions regarding correlating device positional movement to overlap amounts between successive image frames in the image stream. This feedback of information may allow the motion filter module 142 to more efficiently select image frames for placement into the motion filtered image stream 144. This feedback process is also explained in further detail in the U.S. patent application having Attorney Docket No. P10714US1 (119-0226US), which was incorporated by reference above.

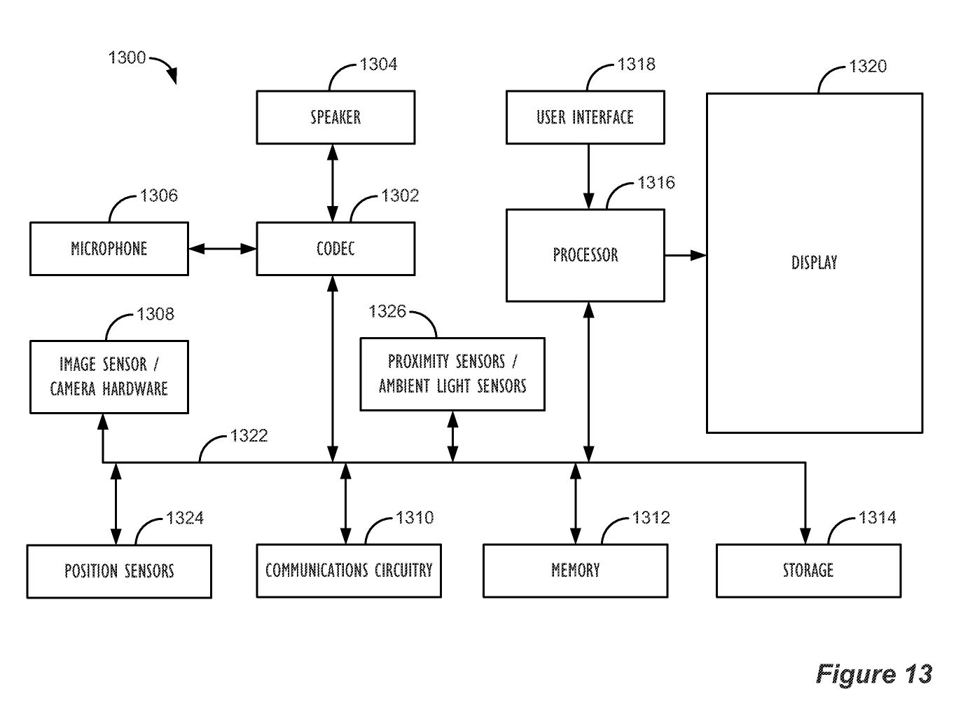

Referring now to FIG. 13, a simplified functional block diagram of a representative electronic device possessing a display 1300 according to an illustrative embodiment, e.g., camera device 308, is shown. The electronic device 1300 may include a processor 1316, display 1320, proximity sensor/ambient light sensor 1326, microphone 1306, audio/video codecs 1302, speaker 1304, communications circuitry 1310, position sensors 1324, image sensor with associated camera hardware 1308, user interface 1318, memory 1312, storage device 1314, and common cations bus 1322. Processor 1316 may be any suitable programmable control device and may control the operation of many functions, such as the generation and/or processing of image metadata, as well as other functions performed by electronic device 1300. Processor 1316 may drive display 1320 and may receive user inputs from the user interface 1318. An embedded processor, such a Cortex® A8 with the ARM® v7-A architecture, provides a versatile and robust programmable control device that may be utilized for carrying out the disclosed techniques, (CORTEX® and ARM® are registered trademarks of the ARM Limited Company of the United Kingdom.)

Storage device 1314 may store media (e.g., image and video files), software (e.g., for implementing various functions on device 1300), preference information, device profile information, and any other suitable data. Storage device 1314 may include one more e storage mediums for tangibly recording image data and program instructions, including for example, a hard-drive, permanent memory such as ROM, semi-permanent memory such as RAM, or cache. Program instructions may comprise a software implementation encoded in any desired language (e.g., C or C++).

Memory 1312 may include one or more different types of memory which may be used for performing device functions. For example, memory 1312 may include cache, ROM, and/or RAM, Communications bus 1322 may provide a data transfer path for transferring data to, from, or between at least storage device 1314, memory 1312, and processor 1316, User interface 1318 may allow a user to interact with the electronic device 1300. For example, the user input device 1318 can take a variety of forms, such as a button, keypad, dial, a click wheel, or a touch screen.

In one embodiment, the personal electronic device 1300 may be a electronic device capable of processing and displaying media such as image and video files. For example, the personal electronic device 1300 may be a device such as such a mobile phone, personal data assistant (PDA), portable music player, monitor, television, laptop, desktop, and tablet computer, or other suitable personal device.

The foregoing description of preferred and other embodiments is not intended to limit or restrict the scope or applicability of the inventive concepts conceived of by the Applicants. As one example, although the present disclosure focused on handheld personal electronic devices, It will be appreciated that the teachings of the present disclosure can be applied to other implementations, such as traditional digital cameras. In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. An image processing method, comprising:
obtaining a first image;
displaying a first scaled version of the first image in a first region of a display at a first time;
storing a full resolution version of a central portion of the first image in a memory;
displaying a second scaled version of the central portion of the first image in a second region of the display at the first time;
obtaining a second image;
replacing the first scaled version of the first image in the first region of the display with a first scaled version of the second image at a second time;
stitching a full resolution version of a central portion of the second image together with the full resolution version of the central portion of the first image to generate a first resultant stitched image, the central portion of the first image and the central portion of the second image sharing an overlapping region;
storing the first resultant stitched image in the memory;
stitching the second scaled version of the central portion of the first image together with a second scaled version of the central portion of the second image to generate a second resultant stitched image, the second scaled version of the central portion of the first image together and the second scaled version of the central portion of the second image sharing the overlapping region; and
displaying the second resultant stitched image in the second region of the display at the second time.

2. The method of claim 1, wherein the act of obtaining a first image comprises:
capturing a full-resolution image of a scene by an image sensor; and
storing the full-resolution image in a memory.

3. The method of claim 1, wherein the act of displaying a first scaled version of the first image in a first region of a display comprises displaying a first scaled version of the first image in a first region of a preview display of an image capture device.

4. The method of claim 1, wherein the act of storing a full resolution version of a central portion of the first image in a memory comprises storing approximately 12.5% of the first image in the memory.

5. The method of claim 1, wherein the first resultant stitched image and the second resultant stitched image are generated substantially simultaneously.

6. A program storage device, readable by a programmable control device, comprising instructions stored thereon for causing the programmable control device to perform the method of claim 1.

7. The program storage device of claim 6, further comprising instructions stored thereon for causing the programmable control device to perform the method of claim 5.

8. An electronic device, comprising:
memory;
an image sensor;
a positional sensor;
a display communicatively coupled to the memory; and
a programmable control device communicatively coupled to the memory, display, positional sensor, and image sensor, wherein the memory includes instructions for causing the programmable control device to perform the method of claim 1.

9. The device of claim 8, wherein the memory further includes instructions for causing the programmable control device to perform the method of claim 5.

10. An image processing method comprising:
receiving a stream of images captured by an image sensor in communication with a device, the stream of images comprising a panoramic scene; and
for each received image:
sending a first portion of data representative of the image down a first graphics pipeline for generating and displaying a real-time preview of the image at the device; and
determining whether to filter the image, and, for each image wherein it is determined that the image will not be filtered:
sending a second portion of data representative of the image down a second graphics pipeline for generating a portion of a panoramic preview of the image,
wherein the generated portion of the panoramic preview of the image is stitched to an existing panoramic preview of the image, creating a resultant panoramic preview of the image, and
wherein the resultant panoramic preview of the image is displayed in real-time at the device.

11. The method of claim 10, wherein the determination to filter a particular image is based at least in part on positional information received at the device.

12. The method of Maim 10, wherein the real-time preview of the image and the panoramic preview of the image are displayed simultaneously on a display.

13. The method of claim 10, wherein the panoramic preview of the image is overlaid on the real-time preview of the image.

14. The method of claim 10, wherein the second portion comprises approximately 12.5% of the image.

15. The method of claim 14, wherein the second portion further comprises approximately the central 12.5% of the image.

16. The method of claim 10, further comprising:
generating with the second graphics pipeline a portion of a panoramic image of the scene;
and appending the generated portion of the panoramic image to the panoramic image of the scene,
wherein the panoramic image of the scene has a higher resolution than the panoramic preview of the image.

17. The method of claim 16, further comprising storing the panoramic: image of the scene to memory.

18. The method of claim 16, wherein the generated portion of the panoramic image has a resolution substantially equal to the full resolution of the camera.

19. The method of claim 16, wherein the panoramic image of the scene has a resolution substantially equal to the full resolution of the camera.

20. The method of claim 16, wherein the real-time preview comprises a scaled version of the image.

21. The method of claim 20, wherein the scaled version of the real-time has a resolution substantially equal to the resolution of a display of the device.

22. The method of claim 16, wherein the generated portion of the panoramic preview of the image has a resolution substantially less than the image.

23. A program storage device, readable by a programmable control device, comprising instructions stored thereon for causing the programmable control device to perform the method of claim 10.

24. The program storage device of claim 23, further comprising instructions stored thereon for causing the programmable control device to perform the method of claim 16.

25. An electronic device, comprising:
memory;
an image sensor;
a positional sensor;
a display communicatively coupled to the memory; and
a programmable control device communicatively coupled to the memory, display, positional sensor, and image sensor, wherein the memory includes instructions for causing the programmable control device to perform the method of claim 10.

26. The device of claim 25, therein the memory further includes instructions for causing the programmable control device to perform the method of claim 16.
